(19) United States
(12) Patent Application Publication
(10) Pub. No.: US 2022/0358249 A1
(43) Pub. Date: Nov. 10, 2022

(54) DYNAMIC ANONYMIZATION OF EVENT DATA

(71) Applicant: Anonomatic, Inc., Menlo Park, CA (US)

(72) Inventor: Matthew Fleck, Pleasant Hill, CA (US)

(21) Appl. No.: 17/723,990

(22) Filed: Apr. 19, 2022

Related U.S. Application Data
(60) Provisional application No. 63/186,693, filed on May 10, 2021.

(51) Int. Cl. G06F 21/62

(52) U.S. Cl. CPC G06F 21/6254

(57) ABSTRACT

A method for anonymizing an event data series including receiving an event information, with (PII) in the event information. Determining if the event information is associated with a session and either creating a new session identifier with a new anonymous identifier or assigning an existing session identifier and existing anonymous identifier in response to said determining, said anonymous identifier associated with the PII and the session, and substituting the PII in the event with the anonymous identifier. Some embodiments may include event which are mouse-clicks or web page visits. Rules for correlating events into sessions may include an allowable amount of time which may occur between the first event in a session and all other events within a session, an allowable amount of time after the start of one event and the start of the next event, or an allowable amount of time for a specific type of event.

### RELATED APPLICATIONS

This application includes by reference U.S. Provisional applications 63/104,853 filed Oct. 23, 2020, 63/069,565 filed Aug. 24, 2020, 63/051,260 filed Jul. 13, 2020, and 63/011,711 filed Apr. 17, 2020, all by the same inventor, and all included by reference, together with their appendices (if any) as if fully disclosed herein.

Moreover, this application claims the benefit of co-pending patent application 63/186,693 filed May 10. 2021 by the same inventor which is included by reference as if fully set forth herein.

### BACKGROUND

A major problem with structured data storage is the ability to maintain confidentiality even if access to the data store is somehow compromised. This is most readily apparent for the storage of medical information, where the Health Insurance Portability and Accountability Act (HIPAA) provides for a very high degree of privacy even within a single institution.

Unfortunately, this high degree of privacy prohibits the easy collation, sharing and transfer of information between people and organizations that could benefit from easy access to the information. For example, and without limitation, a physician treating a person suffering a traumatic injury would not have any way to easily access medical, dental and psychological data from various databases. Even if that data was technically accessible, the HIPAA requirement would bar any personal identifiable information (PII) from being disclosed.

Similarly, large record sets of medical research data needs to be scrubbed of PII before it can be share thus severely limiting the ability to cross index datasets to look for correlations and cross correlations in the data and with person's medical history and treatment.

Different jurisdictions may define very strict rules for data to be considered “Anonymized.” If organizations are not able to fully adhere to these rules there is leeway to provide lesser capability which still delivers on the intent of the regulations. One such set of regulations from the French Data Protection Authority (“CNIL”) have three strict requirements for data to be considered anonymous. These rules prohibit:
Singling out an individual in a dataset
Linking two records within a dataset
Inferring any information in such a dataset

Strict interpretation of these rules makes certain reporting either impossible or useless. For example, and without limitation, in the computer gaming industry events such as mouse-clicks, and web pages interactions may not be properly tracked.

One major concern of using anonymized data is the potential for that data to be re-identified using data in the anonymized data set and potentially data which is available external to the anonymized data. In these cases the risk of re-identification increases with the frequency of a consistent anonymous identifier.

Presented herein are systems and methods for addressing these well-known deficiencies in data management of personal identifiable information.

The construction and method of operation of the invention, however, together with additional objectives and advantages thereof will be best understood from the following description of specific embodiments when read in connection with the accompanying drawings.

### SUMMARY

A method for anonymizing an event data series including receiving, at a server, an event information, and identifying personal identifiable information (PII) in the event information. Determining if the event information is associated with a multi-event session and either creating a new session identifier with a new anonymous identifier or assigning an existing session identifier and existing anonymous identifier in response to said determining, said anonymous identifier associated with the PII and the session, and replacing at least a portion of the PII in the event information with the anonymous identifier, and transmitting the event information over a network. Some embodiments may include event which are mouse-clicks or web page visits. Rules for correlating events into sessions may include an allowable amount of time which may occur between the first event in a session and all other events within a session, an allowable amount of time after the start of one event and the start of the next event, or an allowable amount of time for a specific type of event.

### BRIEF DESCRIPTION OF THE DRAWINGS

FIG. 1 shows a method which may be used in some embodiments.

### DESCRIPTION

### Generality of Invention

This application should be read in the most general possible form. This includes, without limitation, the following:

References to specific techniques include alternative and more general techniques, especially when discussing aspects of the invention, or how the invention might be made or used.

References to “preferred” techniques generally mean that the inventor contemplates using those techniques, and thinks they are best for the intended application. This does not exclude other techniques for the invention, and does not mean that those techniques are necessarily essential or would be preferred in all circumstances.

References to contemplated causes and effects for some implementations do not preclude other causes or effects that might occur in other implementations.

References to reasons for using particular techniques do not preclude other reasons or techniques, even if completely contrary, where circumstances would indicate that the stated reasons or techniques are not as applicable.

References to ‘an event’ generally means a single user action such as selecting an option, landing on a web page, entering data, and the like. An event may also be a single batch process such as where a set of data is all anonymized through the same process at the same time.

Furthermore, the invention is in no way limited to the specifics of any particular embodiments and examples disclosed herein. Many other variations are possible which remain within the content, scope and spirit of the invention, and these variations would become clear to those skilled in the art after perusal of this application.

### Lexicography

The terms “effect”, “with the effect of” (and similar terms and phrases) generally indicate any consequence, whether assured, probable, or merely possible, of a stated arrangement, cause, method, or technique, without any implication that an effect or a connection between cause and effect are intentional or purposive.

The term “relatively” (and similar terms and phrases) generally indicates any relationship in which a comparison is possible, including without limitation “relatively less”, “relatively more”, and the like. In the context of the invention, where a measure or value is indicated to have a relationship “relatively”, that relationship need not be precise, need not be well-defined, need not be by comparison with any particular or specific other measure or value. For example and without limitation, in cases in which a measure or value is “relatively increased” or “relatively more”, that comparison need not be with respect to any known measure or value, but might be with respect to a measure or value held by that measurement or value at another place or time.

The term “substantially” (and similar terms and phrases) generally indicates any case or circumstance in which a determination, measure, value, or otherwise, is equal, equivalent, nearly equal, nearly equivalent, or approximately, what the measure or value is recited. The terms “substantially all” and “substantially none” (and similar terms and phrases) generally indicate any case or circumstance in which all but a relatively minor amount or number (for “substantially all”) or none but a relatively minor amount or number (for “substantially none”) have the stated property. The terms “substantial effect” (and similar terms and phrases) generally indicate any case or circumstance in which an effect might be detected or determined.

The terms “this application”, “this description” (and similar terms and phrases) generally indicate any material shown or suggested by any portions of this application, individually or collectively, and include all reasonable conclusions that might be drawn by those skilled in the art when this application is reviewed, even if those conclusions would not have been apparent at the time this application is originally filed.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Some embodiments disclosed herein include a method for data security including sundering records to parse personally identifiable information (PII) into different fields and replacing the sundered data with anonymous identifiers. These anonymous identifiers may be keyed to both an internal and external identifier such that one receiving the recordset would not be able to ascertain PII.

### System Elements

### Processing System

The methods and techniques described herein may be performed on a processor-based device. The processor-based device will generally comprise a processor attached to one or more memory devices or other tools for persisting data. These memory devices will be operable to provide machine-readable instructions to the processors and to store data. Certain embodiments may include data acquired from remote servers. The processor may also be coupled to various input/output (I/O) devices for receiving input from a user or another system and for providing an output to a user or another system. These I/O devices may include human interaction devices such as keyboards, touch screens, displays and terminals as well as remote connected computer systems, modems, radio transmitters and handheld personal communication devices such as cellular phones, “smart phones”, digital assistants and the like.

The processing system may also include mass storage devices such as disk drives and flash memory modules as well as connections through I/O devices to servers or remote processors containing additional storage devices and peripherals.

Certain embodiments may employ multiple servers and data storage devices thus allowing for operation in a cloud or for operations drawing from multiple data sources. The inventor contemplates that the methods disclosed herein will also operate over a network such as the Internet, and may be effectuated using combinations of several processing devices, memories and I/O. Moreover, any device or system that operates to effectuate techniques according to the current disclosure may be considered a server for the purposes of this disclosure if the device or system operates to communicate all or a portion of the operations to another device.

The processing system may be a wireless device such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality. Alternatively, the entire processing system may be self-contained on a single device.

In some embodiments, a processor-based method may reinterpret ‘record’ to mean a ‘contiguous series of directly related events’ (i.e., a Session) rather than a single event. For example, and without limitation a user coming to a website, searching for a product category, reviewing several specific products and adding one product to the shopping cart would all be considered one ‘Session’ or one ‘Record.’ That same user coming back the next day and finalizing the purchase may be considered a second ‘Session’ or ‘Record.’

In this embodiment an Anonymization Engine would allow a publisher to define certain parameters (rules) such as what constitutes a new Session vs, the continuation of an existing Session. Then intercept the event data as it moves from A (source point) to B (destination point). These parameters may include, but are not limited to: 1) Allowable amount of time which may occur between the first event in a Session and all other events within a Session, 2) Allowable amount of time after the start of one event and the start of the next event, 3) Allowable amount of time for a specific type of event, such as the viewing of a video, and the start of any subsequent event, 4) The type of event which will always define the start of a new Session, 5) whether an event is derived from a user action or from a system process.

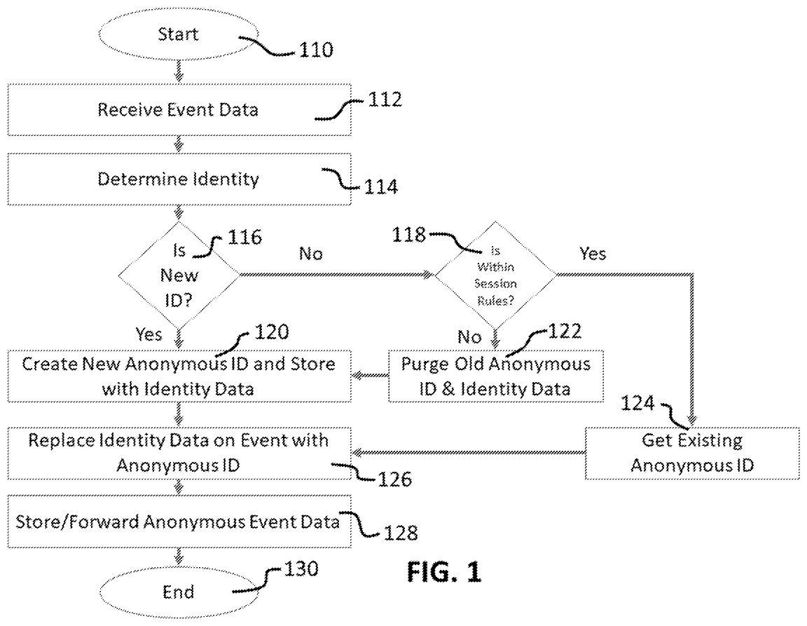

FIG. 1 shows a method which may be used in some embodiments. In FIG. 1, the methods begins at a flow label 110 and proceeds to a step 112.

At a step 112 data is received by a processing device.

At a step 114, an identity determination is made for the source of the data. The identity determination will be specific to the data being provided. In one case it may be as simple as the email address, or account number, of the user which generated the event. In another case it may be a complete or incomplete set of profile attributes such as the person's name, address, a phone number, an identification number or any other value, or set of values, which might be considered Personal Identifiable Information.

At a step 116 a determination is made whether the identity currently has a replacement anonymous identifier, if yes proceed to a step 120, if not proceed to a step 118.

At a step 118, a determination is made whether the data is within the session rules. This step may include querying a rules data source which includes parameters for session membership (i.e. user, IP address, time, and the like). If no, proceed to a step 122, if yes, proceed to a step 124.

At a step 122, optional purging may be performed wherein some portion of the existing information, including both identifying information and the anonymous identifier, may be purged.

At a step 124 the existing Anonymous identifier is use for the session data and flow proceeds to a step 126.

Returning to the step 120, a new anonymous identifier is created and the data is stored using the new anonymous identifier and flow proceeds to a step 126.

At a step 126, identifying data is replaced with the anonymous identifier.

At a step 128 the now anonymous data is forwarded or stored at a desired location.

The methods ends at a flow label 130.

By establishing the identifying attributes within the data, determine if the event is within an existing Session or not. If it is not in a session, create a new Session and anonymous identifier. If it is in a Session, obtain the anonymous identifier from current session. Then replace identifying attributes in event data with the new anonymous identifier and pass the now anonymous event data to destination B.

### Benefits

As shown herein, certain, the spirit of the regulations remains intact. Companies who rely on evaluating contiguous event data may still do so while individual identities are protected. Each Session is essentially a different, fully anonymized, person and multiple Sessions for same individual may not be separated out from rest of the data. And different Sessions may not be linked at the individual level.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

What is claimed:

1. A method for anonymizing an event data series including:
receiving, at a server, event information;
identifying a personal identifiable information (PII) in the event information, said PII including at least one of a name, address, email, or telephone number;
determining if the event information is associated with a session by querying a rules data source, and either creating a new session identifier with a new anonymous identifier or assigning an existing session identifier and existing anonymous identifier in response to said determining, said anonymous identifier associated with the PII and the session;
replacing at least a portion of the PII in the event information with the anonymous identifier, and
transmitting the event information over a network.

2. The methods of claim 1 wherein a session includes a series events associated with a single entity and a session identifier associates multiple events.

3. The method of claim 1 wherein an event includes at least one of a mouse-click, or a web page interaction.

4. The method of claim 1 wherein the rules includes at least on of an allowable amount of time which may occur between the first event in a session and all other events within a session, an allowable amount of time after the start of one event and the start of the next event, or an allowable amount of time for a specific type of event.

5. The methods of claim 1 wherein a session a collection of records, collected at different times and potentially different places, all processed at the same time in a batch process.

5. A method for anonymizing an event data series including:
receiving, at a server, an event information;
identifying a personal identifiable information (PII) in the event information;
determining if the event information is associated with a session and either creating a new session identifier with a new anonymous identifier or assigning an existing session identifier and existing anonymous identifier in response to said determining, said anonymous identifier associated with the PII and the session
replacing at least a portion of the PII in the event information with the anonymous identifier, and
transmitting the event information over a network.

6. The method of claim 5 wherein the PII includes at least one of a name, address, social security number, email address, IP address, device identifier, or phone number.

7. The methods of claim 5 wherein a session includes a series events associated with a single entity and a session identifier associates multiple events.

8. The method of claim 5 wherein an event includes at least one of a mouse-click, or a web page interaction.

9. The method of claim 5 wherein said determining if the event information is associated with a session includes querying a rules data source.

10. The method of claim 9 wherein the rules includes at least on of an allowable amount of time which may occur between the first event in a session and all other events within a session, an allowable amount of time after the start of one event and the start of the next event, or an allowable amount of time for a specific type of event.

11. The method of claim 5 further including:
receiving a session identifier from a remote user;
querying a structured data store for records associated with the session identifier, and
returning to the remote user the results of said querying,
wherein the results of said querying includes multiple records of event associated with a session.

12. One or more processor-readable memory devices encoded with non-transitory processor instruction directing a processor to perform a method including:
receiving, at a server, an event information;
identifying a personal identifiable information (PII) in the event information;
determining if the event information is associated with a session and either creating a new session identifier with a new anonymous identifier or assigning an existing session identifier and existing anonymous identifier in response to said determining, said anonymous identifier associated with the PII and the session
replacing at least a portion of the PII in the event information with the anonymous identifier, and
transmitting the event information over a network.

13. The devices of claim 12 wherein the PII includes at least one of a name, address, social security number, email address, IP address, device identifier, or phone number.

14. The devices of claim 12 wherein 5 wherein a session includes a series events associated with a single entity and a session identifier associates multiple events.

15. The devices of claim 12 wherein an event includes at least one of a mouse-click, or a web page interaction.

16. The devices of claim 12 wherein said determining if the event information is associated with a session includes querying a rules data source.

17. The devices of claim 12 wherein the rules includes at least on of an allowable amount of time which may occur between the first event in a session and all other events within a session, an allowable amount of time after the start of one event and the start of the next event, or an allowable amount of time for a specific type of event.
